(19) United States
(12) Patent Application Publication
(10) Pub. No.: US 2009/0256482 A1
(43) Pub. Date: Oct. 15, 2009

(54) Incandescent Light Bulb

(76) Inventor: John Powell, Newport, NH (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 12/411,541

(22) Filed: Mar. 26, 2009

Related U.S. Application Data
(60) Provisional application No. 61/039,494, filed on Mar. 26, 2008.

(51) Int. Cl. H01K 1/62; H01K 1/02; H01J 9/00

(52) U.S. Cl. 315/51; 313/315; 445/27

(57) ABSTRACT

An improved incandescent light bulb is described utilizing a textured surface filament design to improve efficacy, longevity and color temperature. Embodiments include a low voltage halogen bulb which may be mounted in a fixture containing power condition and altering circuitry. The fixture may be made so as to allow the textured filament bulb to be replaceable. The fixture may also be made so as to fit in a standard household lamp socket as a replacement for existing high voltage incandescent bulbs.

### PRIORITY

This patent claims priority from Provisional Patent Application 61/039,494 filed Mar. 26, 2008 which is incorporated herein by reference.

### TECHNICAL FIELD

The present invention relates to electrical lighting, and more particularly to incandescent light bulbs.

### BACKGROUND INFORMATION

Many companies are in the process of attempting to develop technologies to reduce carbon emissions worldwide. Environmental side effects or manufacturing byproducts are being produced and many more have issues that are common drawbacks to their individual technologies. A good example and a technology that has gained notoriety over the last few years are the Compact Florescent Lights. The Compact Fluorescent Light has an efficacy of approximately 40-60 lumens per watt (lpw); and has been compared to its larger counterpart the larger four and eight foot tube fluorescents. However, the CFL has significantly lower light output as well as an increase in operating temperature, which translates to general temperature losses caused by the inefficient methods used to wrap the fluorescent tube into a smaller package. The smaller package actually blocks exiting light. Most of these compact fluorescent lights are in the 8 to 12 watt range and produce 400 to 600 lumens, and a common issue is that no two produce the same color temperature. In comparison, the typical household Incandescent bulb is 60 watts, producing 700 lumens.

What is needed is an improved incandescent bulb that reduces energy consumption, yet offers consistent and pleasurable color temperature yet does not use hazardous chemicals such as Mercury to pollute our landfills, while still have long useful life.

### BRIEF SUMMARY

(TO BE COMPLETED BY ATTORNEY ON FINALIZATION OF CLAIMS)

### BRIEF DESCRIPTION OF THE DRAWINGS

These and other features and advantages of the present invention will be better understood by reading the following detailed description, taken together with the drawings wherein:

FIGS. 1A and 1B are top and oblique views of a filament wire with increased surface area by means of grooving.

FIG. 2 is a view of a filament wire with increased surface area by means of sputtered surface deposition.

FIG. 3 is a view of a filament wire with increased surface area by means of acid etching.

FIG. 4 is a view of an embodiment of bulb packaging with replaceable bulb element.

Like reference numbers and designations in the various drawings indicate like elements.

### DETAILED DESCRIPTION

The details of one or more embodiments of the invention are set forth in the accompanying drawings and the description below. Other features and advantages of the invention will become apparent from the description, the drawings, and the claims.

Lighting assemblies are typically measured for light output, color temperature, color rendering, efficacy and life. Color temperature is a measurement of how the eye perceives the color of the light. The Color Rendering Index (CRI) is a measure of the ability of a light source to reproduce the colors of various objects being lit by the source. Efficacy is measured as the amount of light given off per watt of power. Typically this is discussed in lumens/watt (lpw). Life is measured in hours of operation under normal environmental conditions.

Table 1 sets out a comparison of standard incandescent bulbs to the compact fluorescents bulbs. Table 1 shows why the compact fluorescent light (CFL) is superior to the typical 120 VAC filament based household incandescent bulb. The CFL's outperform the incandescent on efficacy, life and overall power usage. However, the incandescent is more pleasing to the human eye for color and overall appearance. This is due to the Color Rendering Index.

Incandescent bulbs produce a CRI of 100 where as CFL's are pushing to reach a CRI of 80. This in layman's terms means, the observed colors are true and have a richer feel, the line spectra from a CFL has been shown to promote headaches and eye fatigue in office and home settings.

The Halogen type of incandescent bulb is a improvement over the standard incandescent bulb due to several factors. Low voltage halogen incandescent bulbs utilize a smaller filament in a gas filled vessel. This allows the filament to burn brighter which improves efficacy, luminous output and life. This is due to less gas losses from the filament due to the smaller mass, and the simple fact that the low voltage filament is shorter and has a diameter several times the size of a 120 VAC filament. The larger diameter filament takes much longer to evaporate than the line voltage, smaller diameter filament.

The shorter single coil, low voltage filament also has better shock and support characteristics and makes a better point source for optical designs than longer filament bulbs.

Table 2 compares halogen bulbs to CFLs. As is shown in Table 2, the standard Halogen Incandescent still has dramatic improvements in efficacy, power used and life while having a pleasing color to the human eye.

Running the filament in a standard Halogen light at a lower voltage, with a shorter filament length and housed in an envelope with high fill gas such as halogen, delivers dramatic improvements as shown in the comparisons between Table 1 and 2. As shown, it decreased power consumption substantially over the regular incandescent bulb, If the filament could be improved further, theoretically, this would improve efficacy, life and increase luminous output even further.

The halogen lamp achieves its higher efficacy over the standard incandescent lamp due to the high fill pressure inside; the halogen mix keeps the bulb wall clean throughout life. The filament is the emitter of the light so let's look closer at the design of the filament.

Typical filaments are constructed of tungsten wire. Tungsten generally has an emissivity of about 0.6 or 60% compared to a theoretical black body, a standard measurement technique used in the lighting industry to rate filament output. Although the brightness varies from one material to another, the color (strictly spectral distribution) of the glow is essentially universal for all materials, and depends only on the temperature. In the idealized case, this is known as ‘black body’ or ‘cavity’ radiation, and is described by the well known Planck's Radiation Law.

This 0.6 emissivity (compared to an ideal emissivity of 1)is due in large part to the surface of the tungsten wire. If we sliced through the tungsten wire we would have a cylinder of tungsten.

The amount of light given off of this cylinder per unit volume is proportional to the ratio of the cross sectional area to the circumference, which is equal to the surface area of the wire when we multiply circumference by the length. Increasing the circumference while maintaining the cross sectional area improves the filament by giving more emissive surface for the same cross sectional area.

The maximum permissible current which can pass through the wire is proportional to the cross sectional area of the wire, while the maximum permissible emissivity of the radiated light from the wire is proportional to the circumference, ignoring heat loses.

If we increase the circumference of the wire, increase the surface area of the wire proportionally. It is desirable to maximize the circumference of the wire in relationship to the cross sectional area of the wire, subject to certain limitations discussed below.

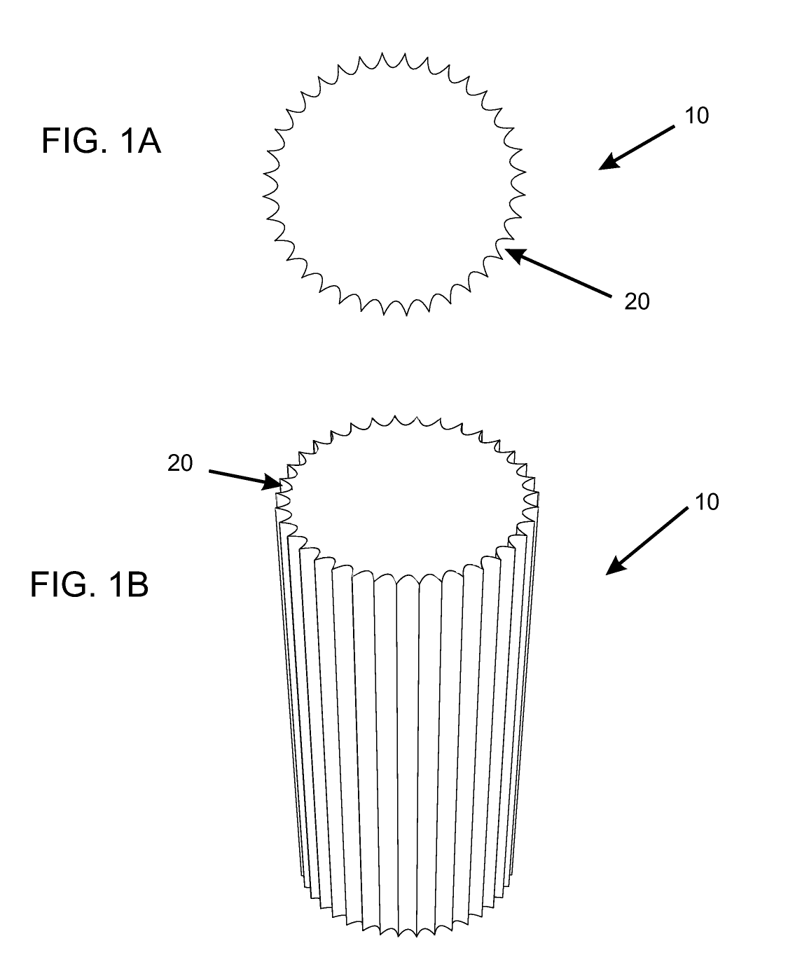

In one embodiment as shown on FIGS. 1A and 1B, we can pass the filament wire thru a finishing die to put grooves into the wire to create a greater surface area. A filament wire 10 is shown having been passed through a finishing die (not shown) to produce grooves 20 in the circumference of the filament wire 10. The overall cross sectional area remains virtually unchanged, while increasing the overall surface area. The resulting benefit is that the same amount of current (energy) can pass through the wire, but now with an increased surface area of the wire we increase efficacy and light output.

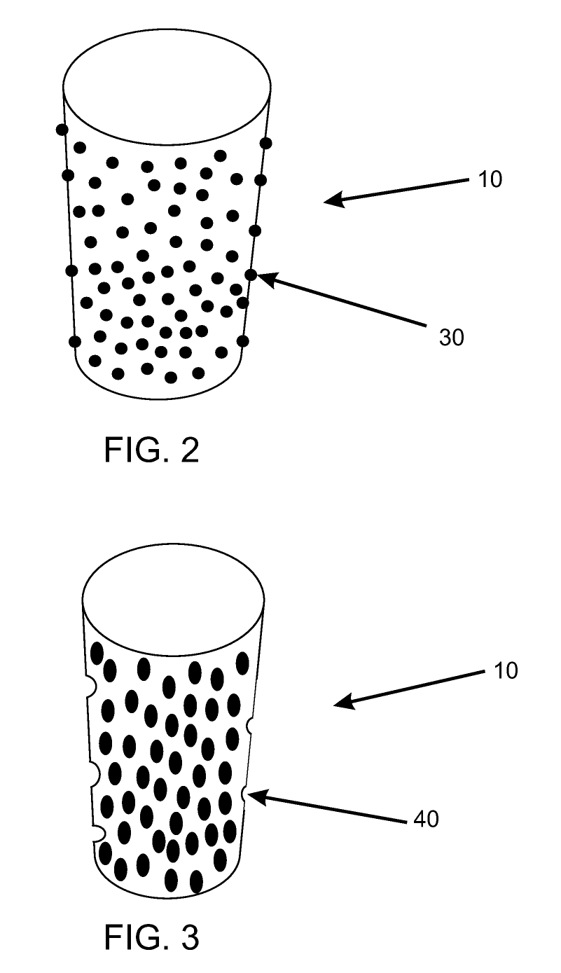

FIG. 2 shows a filament wire 10 on which sputtered surface deposits 30 have been made, as for example by vacuum deposition. Similarly, FIG. 3 shows a filament wire 10 which has surface pitting 40 as by acid etching.

The circumference of the wire is no longer equal to n×d, but the total distance measured around the wire, while maintaining contact with the surface of the wire. In one example, the measured circumference of a unit diameter grooved wire was about 1.67 times longer than a smooth unit diameter surfaced wire. We obtain an overall increase of light output of 37%. If we multiply 24 lpw×1.37 (% gain) we get 32.88 lpw. The 700-lumen 60-watt standard incandescent lamp would be replaced by a 22-watt halogen lamp, with a special drawn grooved filament wire. (723 lm/32.881 pw/95% efficiency).

The 95% efficiency calculation is generated by the efficiency of additional electronics, which steps down the 120 Vac to a lower more efficient filament operating voltage of approximately 14 VAC.

Table 3 makes the same comparison of the improved bulb to the CFL.

When we consider heat loses due to the internal gases, we find the filament design will need to be compensated to counteract this effect. This is accomplished by making the surface grooving (or other surface area increasing surface variations)of a size as will trap the greatest portion of the non-visible infrared light. The new design type of Tungsten filament wire will also have an inherent increase in operating temperature, which will increase efficacy. This is accomplished by the IR wavelengths becoming trapped within the formed longitudinal channels within the wire since the size of the grooves (or surface pitting size or surface particle size) is made so as to be approximately of the same wavelength (700 nm to about 1200 nm)thus making resonant chambers to trap the IR while allowing the shorter wavelength visible to pass. PLEASE CONFIRM THIS.

Two methods that have proven particularly effective to produce a filament wire to create the above-mentioned increase in surface are (1) acidic etching of the completed filament and (2) die finishing.

Etching involves the utilization of sulfuric or other acid under extreme heat (such as 800 degrees Celsius) in a vacuum vessel to create the etching process. This is accomplished by utilizing a standard tungsten filament wire placed in a specially designed glass tube and combined with the acid. The glass tube is then placed under vacuum and inserted into a high temperature furnace. After the heating process, the unit is then removed, cleaned and examined.

The die finishing method improves on the existing method of drawing tungsten wire. Currently tungsten wire is drawn with dies and graphite lubricants. The wire is commonly finished with a chemical or electro-polish, which removes the outer surface of the wire and makes it more uniform and smooth. With the addition of a finish die with grooving mechanisms, and finishing the wire with a wet/dry Hydrogen fire at 1600±200 degrees Celsius to finish and clean the wire, we obtain the desired increase in surface area with a uniform grooving.

In yet another embodiment, voltage conversion circuitry well known in the art may be added to the lamp to provide optimal low voltage power to the bulb. Power may also be converted from AC to DC. Optionally, circuitry well known in the art may be added to limit the peak inrush current which otherwise shortens the life of bulbs at turn on by more than 50%. The result of this additional circuitry is bulb life increase of approximately 3500 to 4500 hours.

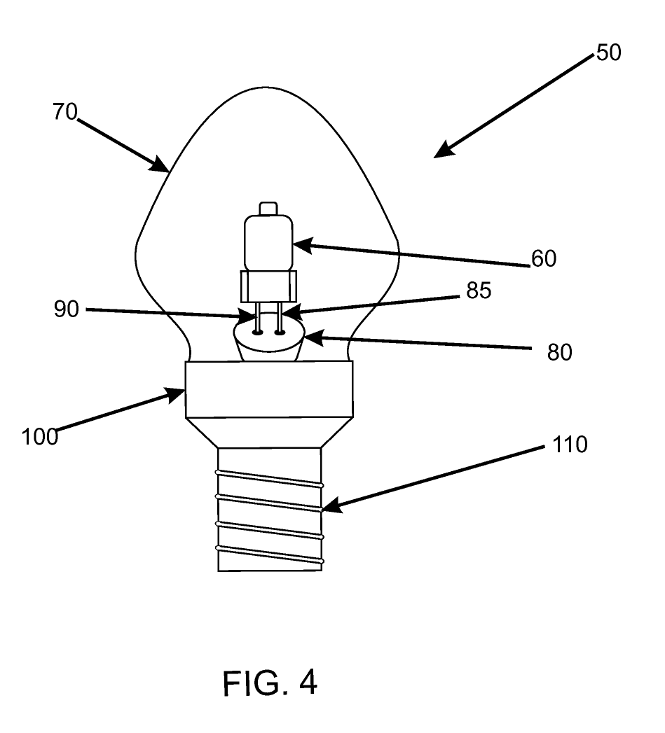

One embodiment of the present invention is shown in FIG. 4 in which packaging configuration 50 is shown. Power conversion circuitry is contained in an upper base portion 100. Such circuitry can contain the inrush current limiting circuitry as well as power conditioning such as voltage change and AC/DC conversion. For example, as shown in FIG. 4, the entire package 50 may be made with a typical household screw-type threaded lamp base 110 designed to access 115 VAC power, and the power conversion circuitry 100 can be made so as to convert 115 VAC to 14 VDC provided to the improved halogen bulb 60. Thus existing incandescent bulbs would be replaceable by a consumer with a package 50 utilizing the improved low voltage bulb 60 and enjoy the benefits such as lower power consumption and bulb life.

For packaging it is desirable to control costs and to make it palatable to consumers. One embodiment of the current invention utilizes a replacement methodology. The outer bulb enclosure 70 may be made of polymers or other translucent material that are heat/fire resistant. The outer bulb enclosure 70 may be made so as to be removable from a main standard light bulb base 110. The inner halogen bulb 60, as described herein, may be removably inserted into a secure socket 80 of a type well known in the art that is electrically connected to the power conditioning circuitry. The electronics 100 may be attached to this socket 80 and the outer bulb base 110, which may be any appropriate type such as an Edison socket as used in home lamps or style E26, E27 etc This will allow the inner bulb 60 to be replaced and the remainder of the assembly to be re-used. A potting or sealant may be utilized to encapsulate the electronics area to ensure longevity, safety and integrity of the assembly.

The improved incandescent bulb has a CRI of 100, so colors will look real, the color temperature will be somewhere around 3500K which is a cooler white, just above the current halogens. The improved bulb is made from materials so as to be shatter proof and safe around people with lower touch temperatures due to the drop in wattage. The improved light bulb does not contain any Mercury to pollute our environment; it can be manufactured more inexpensively than compact fluorescent and easier on the eyes from lack of flicker and the line spectra emitted from fluorescents.

The invention has been described in terms of particular embodiments. Other embodiments are within the scope of the following claims. For example, the steps of the invention can be performed in a different order and still achieve desirable results. Modifications and substitutions by one of ordinary skill in the art are considered to be within the scope of the present invention, which is not to be limited except by the following claims.

TABLE 1
Incandescent vs. Compact Fluorescent Bulbs

| Quantitative | Incandescent | Compact Fluorescent |
|---|---|---|
| Measurement | Household Bulb | Light (CFLs) |
| Typical Wattage | 60 watts | 14-18 watts |
| Construction | Filament | Gas |
| Operating Voltage | 120 VAC | 120 VAC |
| Efficacy | 11.6 lpw | 56.4 lpw |
| Luminous Output | 700 lumens | 400-600 lumens |
| CRI | 100 | ~80 |
| Color Temperature | ~2750-3000 K | ~5200-5500 K |
| Life | ~1000 Hours | ~8000 hours (Note#1) |

(Note#1)
Actual hours of a Compact Florescent light is not the posted average rated lab life hours, true Florescent life is significantly affected by the number of starts and many factors not generally discussed with the general public. True life of many Florescent Compact lamps are typically between 1000 to 3000 hours, with the electronics also contributing to the end of life.

TABLE 2
Standard Halogen Incandescent vs. Compact Fluorescent Bulbs

| Quantitative | | Compact Fluorescent |
|---|---|---|
| Measurement | Halogen Bulb | Light (CFLs) |
| Typical Wattage | 22 watts | 14-18 watts |
| Construction | Low Volt Filament | Gas |
| | w/gas envelope | |
| Operating Voltage | 14 VAC | 120 VAC |
| Efficacy | 24.6 lpw | 56.4 lpw |
| Luminous Output | 541 lumens | 400-600 lumens |
| CRI | 100 | ~80 |
| Color Temperature | ~3000-3500 K | ~5200-5500 K |
| Life | ~1500 Hours | ~8000 hours (Note#1) |

(Note#1)
Actual hours of a Compact Florescent light is not the posted average rated lab life hours, true Florescent life is significantly affected by the number of starts and many factors not generally discussed with the general public. True life of many Florescent Compact lamps are typically between 1000 to 3000 hours, with the electronics also contributing to the end of life.

TABLE 3
Improved Technology Halogen Incandescent
vs. Compact Fluorescent Bulbs

| Quantitative | | Compact Fluorescent |
|---|---|---|
| Measurement | Halogen Bulb | Light (CFLs) |
| Typical Wattage | 22 watts | 14-18 watts |
| Construction | Filament w/gas | Gas |
| | envelope | |
| Operating Voltage | 120 VAC (Note # 2) | 120 VAC |
| Efficacy | 32.9 lpw | 56.4 lpw |
| Luminous Output | 723 lumens | 400-600 lumens |
| CRI | 100 | ~80 |
| Color Temperature | ~3000-3500 K | ~5200-5500 K |
| Life | ~4000 Hours | ~8000 hours (Note #1) |

The invention claimed is:

1. An incandescent light bulb having a filament, said filament comprising a wire, said wire having a longitudinal axis, and said wire having a textured surface.

2. The incandescent bulb of claim 1 where said textured surface comprises channels substantially parallel to said longitudinal axis of said wire.

3. The incandescent light bulb of claim 2 wherein said channels are from 700 to 1200 nanometers in width.

4. The incandescent light bulb of claim 1 wherein said textured surface comprises pitting.

5. The incandescent light bulb of claim 4 wherein said pitting is to a depth of between 700 nanometers and 1200 nanometers.

6. The incandescent light bulb of claim 1 wherein said textured surface comprises surface particles.

7. The incandescent light bulb of claim 6 wherein said surface particles are 700 nanometers to 1200 nanometers large.

8. The incandescent light bulb of claim 7 wherein said surface particles are deposited on said wire by means of vacuum deposition.

9. The incandescent light bulb of claim 1 wherein the said light bulb comprises a base; said base further comprising an electrical circuit disposed between the electrical contacts of the bulb base and the filament, said circuit further comprising components to limit the current supplied to the filament when energized.

10. The incandescent light bulb of claim 1 wherein the said light bulb comprises a base and a bulb base having electrical contacts; said base further comprising an electrical circuit disposed between and electrically connected to said electrical contacts of said bulb base and said filament, said circuit designed to convert the electric power applied to said base to a power applied to said filament.

11. The incandescent bulb of claim 10 wherein the said electrical circuit converts the voltage applied to said filament to between ten and fifteen volts.

12. The incandescent light bulb of claim 10 wherein the said filament is mounted in an enclosed capsule which is removable from said base.

13. The incandescent bulb of claim 10 wherein said electrical circuit coverts AC power to DC power.

14. The incandescent light bulb of claim 10 wherein said bulb base comprises a standard household light bulb base electrically connected to said electrical circuit.

15. A method of making an improved incandescent light bulb filament by providing a filament wire and increasing the surface area of said filament wire by texturizing the said filament wire surface.

16. The method of claim 15 wherein the said texturizing comprises passing the said filament wire through a die which forms grooves in said filament wire surface.

17. The method of claim 15 where said texturizing comprises acid etching said filament wire.

18. The method of claim 15 where said texturizing comprises sputtering deposition.

19. The method of claim 15 further comprising mounting said filament wire in a bulb; providing said bulb with a plug electrically connected to said filament wire;
providing a fixture, said fixture further comprising a translucent dome, said fixture further comprising a base said base comprising a top and a bulb base, removably mounting said dome on the top of said base,
providing aid bulb base with means for connecting to a power source; said bulb base further comprising electronic circuitry for conditioning power received from said power source to a form appropriate to light said filament wire;
providing said bulb base with means for mounting said bulb within said dome; electrically connecting said mounting means with said electronic circuitry; mounting said bulb in said mounting means.
